(19) United States
(12) Patent Application Publication
(10) Pub. No.: US 2003/0013530 A1
(43) Pub. Date: Jan. 16, 2003

(54) Lottery club system

(75) Inventor: Jeffrey P. Lauzon, West Bloomfield, MI (US)

Correspondence Address: Kevin J. Heinl, Brooks & Kushman P.C., 22nd Floor, 1000 town Center, Southfield, MI, 48075-1351, US

(73) Assignee: TeleCents Communications Inc., Walled Lake, MI (US)

(21) Appl. No.: 10/194,631

(22) Filed: Jul. 12, 2002

Related U.S. Application Data
(60) Provisional application No. 60/304,992, filed on Jul. 12, 2001.

(51) Int. Cl. G06F 17/00

(52) U.S. Cl. 463/42

(57) ABSTRACT

In a lottery club system a method of establishing a lottery club is disclosed. A lottery club membership package is purchased by a consumer who then follows instructions via an interactive communication system to register the consumer as a member of the lottery club. An account is set up for the consumer within a lottery club that is assigned by the system. Lottery numbers are assigned to the lottery club and lottery tickets are purchased corresponding to the lottery club numbers. The system provides for identification and payment of lottery winnings for a predetermined set of lottery drawings.

### CROSS REFERENCE TO RELATED APPLICATIONS

This application claims the benefit of U.S. provisional application Serial No. 60/304,922, filed Jul. 12, 2001.

### BACKGROUND OF THE INVENTION

1. Field of the Invention

The present invention relates to a system for creating a lottery club that may be joined by purchasing a lottery club membership at a retail outlet.

2. Background Art

Lotteries conducted by government organizations are generally conducted on a weekly basis and require that a person purchase a ticket for each lottery drawing. While lotteries may offer a large windfall to a winner, the odds of winning a lottery are very small. To increase chances of winning and reduce the cost of playing multiple numbers, some people would prefer to play the lottery as a member of a lottery club. Most lottery clubs are created as workplace groups. Individuals outside of the workplace where a lottery club has been established are not normally welcome to participate in the lottery club.

There is a need for a system that facilitates the organization of lottery clubs so that persons unrelated to each other and who do not work together may still participate in a lottery on a lottery club basis.

### SUMMARY OF THE INVENTION

According to one aspect of the invention, a system is provided for allowing a consumer to purchase a lottery club membership at a retail outlet. A club membership allows a consumer to buy a membership package from a retail store, go home and dial a toll-free number that guides the consumer through the membership process.

The communication system issues voice prompts that guide the consumer through the membership process. Upon joining a lottery club, the consumer is given a first drawing date and a last drawing date which will be calculated by the number of draws entered when the account numbers were generated. Initially, ten and twenty dollar memberships will be available.

A club member is provided with a telephone number to call to check if any of the club member's lottery numbers were drawn as winning numbers. After all of the drawings in which a club member is to participate have been drawn, the membership in the club is deactivated and removed from the lottery club system.

According to another aspect of the invention, a customer interface will be provided to communicate with consumers to set up new memberships. The system will also include management tools, such as reports, billing statements, updates, and other normal business functions.

An administrator purchases a lottery ticket corresponding to each lottery club's numbers in advance of the drawings. When a lottery number wins, the administrator pays off the club members on a pro rata basis.

### BRIEF DESCRIPTION OF THE DRAWING

FIG. 1 is a flow chart showing a lottery club system of the present invention; and

FIGS. 2A and 2B are a software flow chart showing the representative set of steps for the software built to implement the lottery club system of the present invention.

### DETAILED DESCRIPTION OF THE PREFERRED EMBODIMENTS

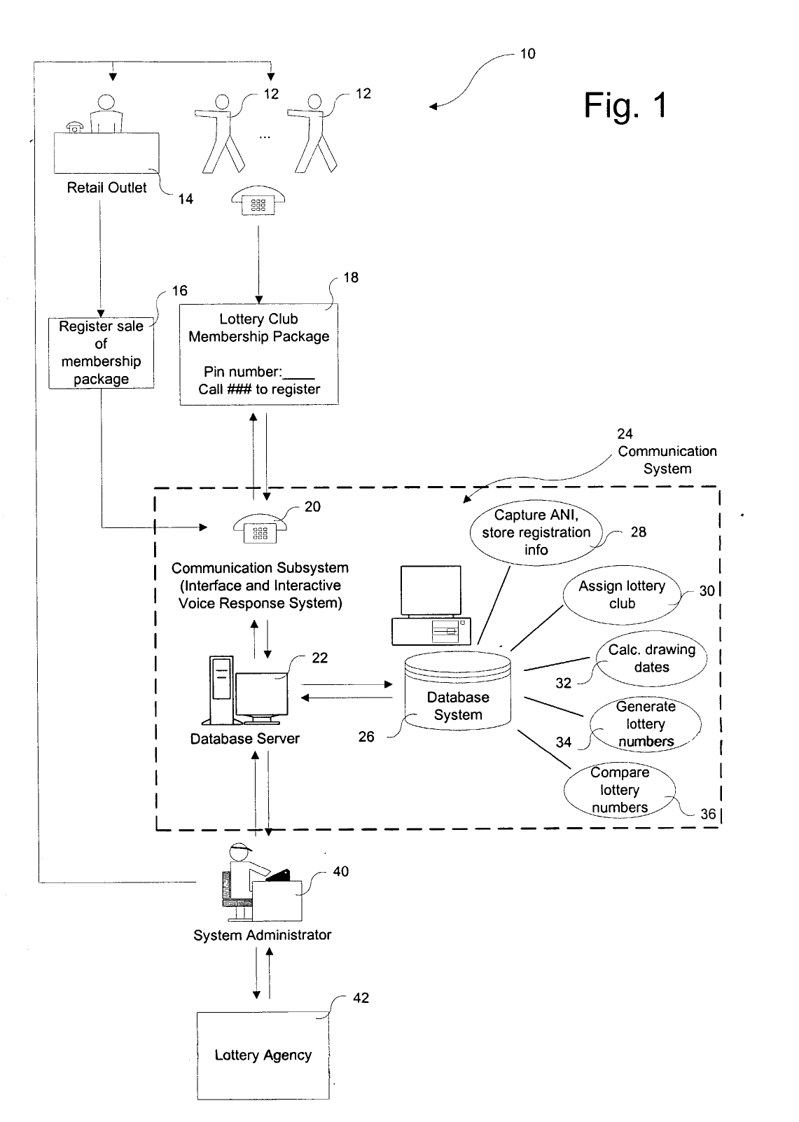

Referring now to FIG. 1, the lottery club system is described in general terms. The system 10 begins with a consumer 12 purchasing a lottery club package at a retail outlet 14. It should be understood that the lottery club package could be purchased via Internet sources or another retail source. The retail outlet or other purchasing agent registers the sale of the membership package at 16. The consumer 12 telephones or otherwise contacts the lottery club using information obtained from the lottery club membership package. When the consumer 12 contacts the lottery club, the interactive voice response system within the communication subsystem prompts the consumer 12 to provide a PIN number contained within the membership package and communicates that PIN number via communication subsystem or interface and interactive voice response system 20.

A communication subsystem 20 and database server 22 managing a database system 26 form the basis of the communication system. The system may be customized, but general functions include the system processing memberships, calculating set-up dates, and determining the first and last drawing dates for the consumer.

The database system 26 is programmed to capture the automatic number identification (ANI) of the telephone used to register the consumer's lottery club membership package. The database system also assigns the consumer 12 to a lottery club at 30 and calculates drawing dates for each lottery club at 32. The database system is also operable to generate random lottery numbers at 34. The randomly generated lottery number picks are compared with actual winning lottery numbers at 36 by the database system 26. The database system stores the lottery numbers for each club and, for example, may store at least six lottery numbers per lottery club.

Turning now to the implementation of the database system 26, it is anticipated that the database will support a network accessible form via a pull-down menu for creation of membership accounts. The form is expected to contain several fields, including a dollar value corresponding to the retail value of the membership package. The system also generates a starting sequence number that is automatically generated based upon the last sequence number and then incrementing that number by one. The quantity value is manually entered and must have a value entered that is less than a predetermined number. Next, an ending sequence is automatically generated by adding the quantity to the starting sequence number field and the ending sequence number is displayed on the screen. A final field corresponding to the number of draws is entered and is used to determine how many drawings the account number may participate in once it has been activated. Based upon this information, the system permits a specified number of ten and twenty dollar accounts to be created.

A system administrator 40 interacts with the database server 22 and also communicates with the retail outlet 14 and consumer 12. The system administrator 40 interacts with the lottery agency 42, such as a state lottery agency, a multi-state lottery agency, or private lottery. The system administrator purchases lottery tickets from the lottery agency 42 and receives winnings from the lottery agency that are distributed to the consumers 12 when a number assigned to a lottery club is selected by the lottery agency 42 as a winner.

New lottery clubs may be created according to the following procedure. First, the type of club is selected (i.e., what lottery is to be played). The system then assigns a lottery club number. Next, the number of lottery clubs to be created is entered. The system then selects lottery ticket numbers. The system is capable of generating a plurality of lottery numbers randomly for each lottery club created. The lottery numbers must conform to the numbers available in a particular lottery with appropriate limitations based upon the lottery game rules, such as that a selected number may or may not appear twice in a lottery drawing.

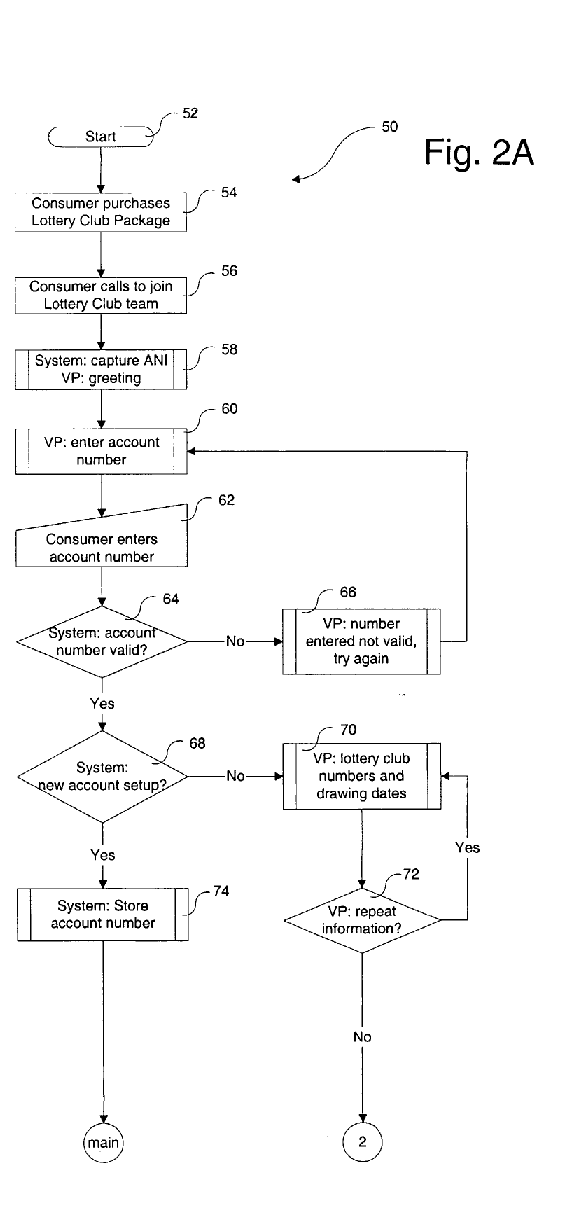

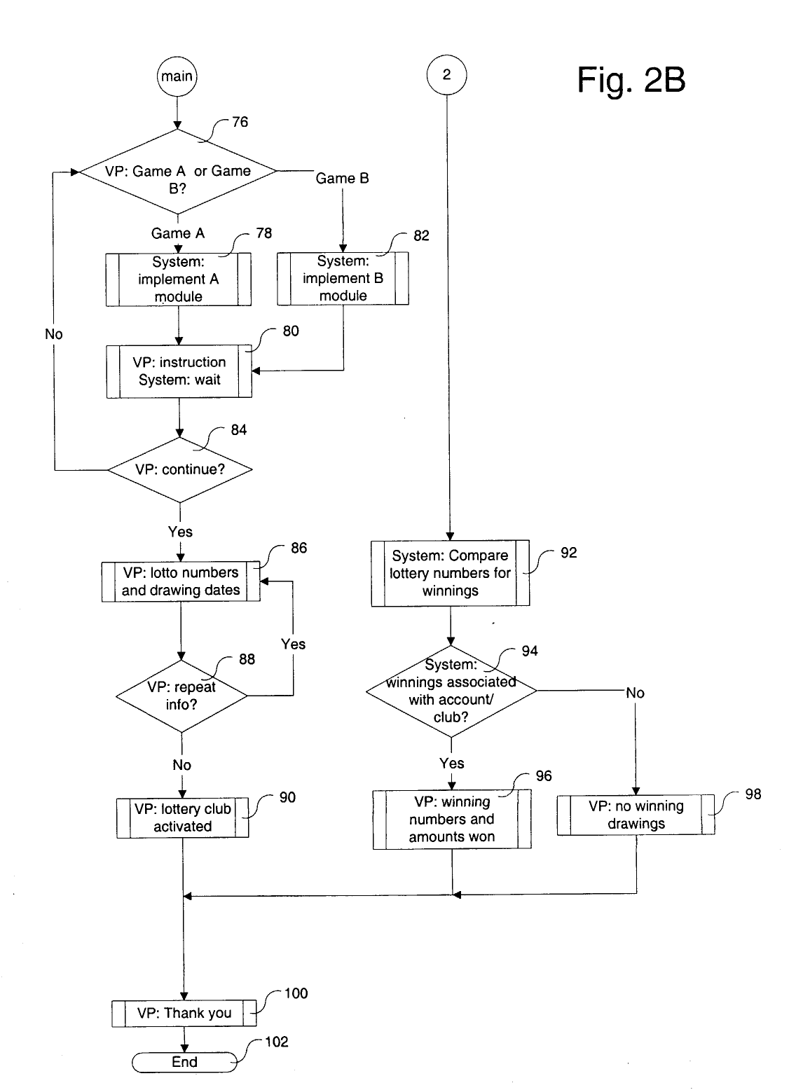

Referring now to FIGS. 2A and 2B, the interactive telephonic interface and interactive voice response system is illustrated in detail. The process begins at the starting point designated by reference numeral 52. The consumer begins the process by purchasing a lottery club package as at 54. After the consumer purchases the lottery club package, they call to join the lottery club team as at 56.

The telephone call made is routed through the communication system preferably to a phone system that is limited to receiving incoming calls. The ANI of the caller is captured for future identification thereof and the interactive voice response system provides a voice prompt greeting at 58. One way that the ANI may be used is that it may be compared to the ANIs of other lottery club members when the lottery club is set up so that if a consumer buys more than one membership package they will not be placed in the same club multiple times. The ANI may also be used to facilitate notification of winning club members and for verification of the identity of winners who are required to prove that they purchased the winning package and may also be required to confirm the ANI of the telephone used to register.

A voice prompt is provided to the consumer to enter the account number appearing on the lottery club package at 60. In response, the consumer enters the account number at 62. The system then determines whether the account number is valid or authorized. If the account number is not valid or the consumer has made a mistake in entering the account number, the system provides a voice prompt at 66 indicating that the number entered is not valid and requests the consumer to try to enter the account number again returning to the Enter Account Number step at 60. A counter (not shown) would be provided that would permit a limited number of attempts to enter an account number. Upon exceeding the limited number of attempts the system would terminate. If the system account number is valid, the system determines at 68 whether it is a new account set up. If it is not a new account set up, the system provides a voice prompt at 70 listing lottery club numbers and drawing dates for the account number. The system also provides an opportunity at 72 to repeat the lottery club number and drawing date information if the consumer requires that it be repeated or confirmed. If the system determines that a new account is to be set up, then the system stores the account number at 74 and continues through a voice prompt to determine what game the lottery club membership is intended to be registered for at 76. If the consumer hangs up before completing the registration process, the system does not register the consumer's lottery club membership.

The lottery club may be limited to a single lottery or may allow a consumer to register with one lottery selected from several lotteries. In the illustrated embodiment, two lotteries, designated Game A and Game B are shown as being available. After it is determined which game, either game A or game B, that the consumer is to be registered for, the system will proceed to implement the corresponding module. If the consumer is to be registered for game A, the system proceeds to implement the module for game A at 78. If the consumer has purchased a registration for game B, then the system will indicate the game B module at 82. After the selected module has been implemented, the system moves to 80 and waits while the voice prompt recites instructions for the game type selected and prepares the consumer to receive the lottery numbers and drawing dates.

After the waiting and instruction period at 80, the system inquires as to whether the registration portion should continue. If so, the system provides lottery numbers and drawing dates at 86. A voice prompt is provided to repeat the information to be sure that the consumer has had an adequate opportunity to record the lottery numbers and drawing dates. If it is not necessary to repeat, the voice prompt at 90 confirms that a lottery club as been activated.

If the account is not a new account set up but is an inquiry to determine if a previously set up account number has won, the system may compare lottery numbers for winnings at 92. The system determines, at 94, whether winnings have been associated with the account or lottery club. If the lottery club has a winning number, a voice prompt is provided at 96 indicating what the winning numbers were and also indicating the amount of money won. If the system determines that there are no winnings associated with the account or lottery club, the system provides a voice prompt reciting that there were no winning numbers selected in the drawings at 98. The system is terminated with a voice prompt at 100 thanking the consumer for participating in the lottery club. The system ends operation at 102.

The lottery club utilizes four primary tables within a database. The four primary tables include a table for account information, a table for distributor information, and a table for each lottery that may be participated in by a club.

Different lotteries will have different constraints based upon the drawing date, frequency and lottery number format. For example, a lottery club having 20 members can be set up by 20 separate people purchasing a club membership and registering to participate using the system. The system, upon initial inquiry by a new member, selects a club having less than 20 members and checks to ascertain whether the member's ANI is presently represented in the club. The system sets up the current date of the registration call and then calculates the first drawing date the member is eligible to participate in. The system also calculates the last drawing date that a member is eligible to participate in based upon the number of drawings selected. The system updates the database with the new member's information and records the new member's ANI. If a winner is selected, the ANI may be used to contact the lottery club member.

The system is programmed to check all accounts on a regular basis to determine whether an account should be removed from the lottery club membership.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method of establishing a lottery club comprising a group of consumers who jointly play a set of lottery numbers in a lottery game, comprising:
preparing a lottery club membership package having a set of instructions for initiating a membership procedure;
selling the lottery club membership package to a consumer;
interacting with the consumer to register the consumer as a member;
setting up an account for the consumer wherein the consumer is assigned to a lottery club;
generating a set of lottery numbers that are assigned to the lottery club; and
comparing a winning lottery number to each lottery number in the set of lottery numbers assigned to the lottery club.

2. The method of establishing a lottery club of claim 1 wherein the interacting step further comprises recording an ANI of a telephone used to register the consumer and if any of the lottery numbers in the set of lottery numbers assigned to the pool are to be paid, notifying the consumer by calling the ANI recorded for the consumer.

3. The method of establishing a lottery club of claim 1 wherein the interacting step further comprises recording an ANI of a telephone used to register the consumer and in conjunction with the step of setting up the account further comprising checking a plurality of recorded ANI numbers of other members of the club against the ANI of the telephone used to register the consumer so that the consumer will not be registered in the same lottery club more than once.

4. The method of establishing a lottery club of claim 1 wherein the step of preparing the lottery club membership package further comprises providing a telephone number of lottery club system that is called by the consumer.

5. The method of establishing a lottery club of claim 1 wherein a plurality of lottery club rounds are played by the lottery club.

6. The method of establishing a lottery club of claim 5 wherein in each of the lottery club rounds the same set of lottery numbers are played by the lottery club.

7. The method of establishing a lottery club of claim 5 wherein the lottery club is deactivated when the last of the plurality of rounds are drawn.

8. The method of establishing a lottery club of claim 5 wherein when the consumer is registered as a member a first drawing date and a last drawing date are assigned and the set of lottery numbers assigned to the lottery club are assigned by a database system operable to generate random numbers limited to numbers permitted to be played by the lottery.

9. The method of establishing a lottery club of claim 1 further comprising providing a telephone number for the consumer to call that reports to the consumer the result of the comparing step.

10. The method of establishing a lottery club of claim 1 wherein the step of interacting with the consumer comprises using a communication subsystem that queries the consumer to obtain registration information.

11. A method of selling lottery tickets for a lottery, comprising:
preparing a lottery club kit including a registration identification code and a set of instructions for joining a lottery club;
selling the lottery club kit to a person who wants to play a plurality of lottery number sequences and share the cost of playing with the lottery club;
joining the lottery club by the person who contacts a lottery club communication system in accordance with the set of instructions, the lottery club communication system having a database for registering the person in the lottery club by assigning the registration identification code to the lottery club;
generating the plurality of lottery number sequences and assigning the numbers to the lottery club; and
paying the persons in the lottery club on a pro rata basis if any of the generated lottery numbers match a winning lottery number sequence selected in a lottery drawing.

12. The method of claim 11 wherein the step of joining the lottery club further comprises persons contacting the lottery club communication system by telephone and activating a telephonic interface and an interactive voice response unit that queries the persons to obtain registration information.

13. The method of claim 11 further comprising the step of notifying the persons in the lottery club of the plurality of lottery numbers after registration.

14. The method of claim 11 further comprising the step of notifying the persons in the lottery club of the lottery number sequence selected and as to each of the plurality of lottery numbers that match the lottery number sequence after selection.

15. The method of claim 11 wherein the lottery club kit further includes a form for recording the plurality of lottery numbers when the person is notified as to the identity of the plurality of numbers.

16. The method of claim 11 further comprising the step of the administrator purchasing all of the plurality of lottery number sequences assigned to the lottery club after registration for the lottery drawing.

17. The method of claim 16 wherein the lottery club is registered to participate in a predetermined series of lottery drawings and the administrator purchases all of the plurality of lottery number sequences for each lottery drawing in which the lottery club is registered to participate.

18. The method of claim 11 wherein the step of generating the plurality of lottery number sequences is performed by a database system operable to generate numbers limited to the numbers selectable by the lottery drawing.

19. The method of claim 11 wherein the step of joining the lottery club further comprises persons contacting the lottery club communication system by telephone and recording in the database an ANI of the telephone used to register the person.

20. A method of organizing a lottery club to allow a group of consumers to participate in a lottery wherein the consumers in the lottery club jointly participate in a lottery game share in a pool of lottery numbers, comprising:
providing a lottery club membership package purchased by a consumer, the package having contact information that the consumer utilizes to register with the lottery club;
associating the lottery club with each of the consumers;
generating a plurality of lottery numbers that the lottery club plays on a joint basis;
calculating the drawing dates on which the actual lottery numbers will be drawn; and
comparing a winning lottery number to the lottery numbers in each lottery game.

21. A lottery club system comprising:
a lottery club membership package having a set of instructions and a code for initiating a membership procedure;
a communication system accessible by following the instructions and entering the code, the communication system being operative to interact with a consumer and a system administrator, and operative to receive, store and process registration and lottery club information to register the consumer as a member of a lottery club and designate a set of lottery numbers to the lottery club;
the communication system issuing instructions to purchase the set of lottery numbers assigned to the lottery club from a lottery agency;
the communication system comparing a winning set of lottery numbers selected by the lottery agency to the set of lottery numbers assigned to the lottery club; and
the communication system issuing instructions to pay the members of the lottery club on a pro rata basis if the set of lottery numbers wins the lottery.

22. The lottery club system of claim 21 wherein the communication system further comprises:
a communication subsystem having a communication interface and an interactive voice response unit programmed to interact with a consumer and a database server;
a database server programmed to manage information routed to and from the communication subsystem and a database system; and
a database system for storing and processing registration information corresponding to each consumer, the database system being electronically accessible by the database server.

23. The lottery club system of claim 22 wherein the database system is operable to capture an ANI of a telephone used to register the consumer such that if any of the lottery numbers in the set of lottery numbers assigned to the pool are paid, the consumer is notified by calling the ANI recorded for the consumer.

24. The lottery club system of claim 22 wherein the database system is operable to assign a predetermined number of consumers to the lottery club and the database system is operable to capture an ANI of a telephone used to register the consumer such that if the ANI matches an ANI of any other of the predetermined number of consumers, the consumer will not be registered in the same lottery club.

25. The lottery club system of claim 22 wherein the database system is operable to calculate the drawing dates on which the actual lottery numbers will be drawn.

26. The lottery club system of claim 22 wherein the database system is operable to generate lottery numbers limited to the numbers selectable by the lottery drawing.

27. The lottery club system of claim 22 wherein the database system is operable to compare a winning set of lottery numbers to the set of lottery numbers in each lottery game.

28. The lottery club system of claim 22 wherein the database system is operable to deactivate the lottery club when the last of the plurality of rounds are all drawn.

29. The lottery club system of claim 21 wherein the system administrator communicates with the lottery agency to purchase the set of lottery numbers in each lottery game.

30. The lottery club system of claim 21 wherein the system administrator issues payment on a pro rata basis to the consumer such that if any of the lottery numbers in the set of lottery numbers assigned to the pool are paid.

31. The lottery club system of claim 22 wherein the communication interface is a telephonic interface.
